(19) United States
(12) Patent Application Publication
(10) Pub. No.: US 2010/0080661 A1
(43) Pub. Date: Apr. 1, 2010

(54) Construction of chemically treated erosion control blanket to enhance erosion control performance and improve soil stability

(76) Inventor: Chad M. Lipscomb, Fort Collins, CO (US)

Correspondence Address: Donald N. Halgren, 35 Central Street, Manchester, MA, 01944-1311, US

(21) Appl. No.: 12/584,724

(22) Filed: Sep. 10, 2009

Related U.S. Application Data
(63) Continuation-in-part of application No. 12/214,628, filed on Jun. 20, 2008.
(60) Provisional application No. 60/936,603, filed on Jun. 21, 2007.

(51) Int. Cl. E02D 17/20; B32B 3/18

(52) U.S. Cl. 405/302.7; 156/70

(57) ABSTRACT

A multi-layered surface control blanket for soil stability and turf management, comprising a sandwiching of: a fluid permeable lower layer of flexible material; a fluid permeable upper layer of flexible material; at least one intermediate layer of fibrous material treated with a displaceable chemical agent, wherein the chemical agent consists of a soil treatment agent selected from the group comprising: a tackifier, a flocculant, and a polyacrylamide.

### BACKGROUND OF THE INVENTION

1. Field of the Invention

This invention relates to erosion control blankets and more particularly to treated blankets for enhancing the blankets to control soil more aggressively thereunder, and is based upon U.S. Provisional Patent Application Ser. No. 61/191,612 filed 10 Sep. 2008, and U.S. patent application Ser. No. 12/214,628, filed 20 Jun. 2008, each of which are incorporated herein by reference in their entirety.

2. Prior Art Discussion

Erosion control blankets are typically rolled products utilized to keep turf and property adjacent waterways etc from being lost during storms and natural causes. Such causes are rainfall, flowing water of the rise and fall of shoreline waters (wave attack).

Such erosion control blankets may be divided into two categories, temporary (degradable) and permanent (non-degradable). The temporary blankets may be called “erosion control” blankets and the permanent blankets which add systemic support to vegetative systems are referred to as “turf reinforcing” mats.

A blanket found in the prior art is shown in US patent to white as U.S. Pat. No. 5,237,945 entitled water barrier formed from a clay fiber mat. This patent discloses a water barrier fabric filled with a water absorbent material such as granular bentonite clay. This type of product merely acts as a shield and fails to provide a stable soil layer beneath that mat.

It is an object of the present invention to provide a soil stabilizing mat which provides a conditioning to the soil over an extended period of time.

It is yet a further object of the present invention to provide a soil stabilizing mat which contributes to the stability of the soil over an extended period of time.

Is yet a further object of the present invention to provide a multi-layered mat which also has absorbency characteristics.

It is yet a further object of the present invention to provide a single or multi-layered mat arrangement which may be utilized on surfaces other than soil, for example, liquids, oil spills, gasoline or hazardous waste leakages.

It is an object of the present invention to improve upon the disadvantages of the prior art.

It is a further object of the present invention to incorporate the characteristics of both of the permanent and temporary blankets to maximize the effectiveness of the final product.

### BRIEF DESCRIPTION OF THE DRAWINGS

The objects and advantages of the present invention will become more apparent when viewed in conjunction with the following drawings, in which:

FIG. 1 is a side elevational view of a production line for adding a soil stabilizing treatment by an agent dropping arrangement to a blanket undergoing assembly;

FIG. 2 is a side elevational view of a production line for adding a soil stabilizing treatment by a painting arrangement to a blanket undergoing assembly;

FIG. 3 is a side elevational view of a production line for adding a soil stabilizing treatment by a spray application of liquid or powder or the like arrangement to a blanket undergoing assembly;

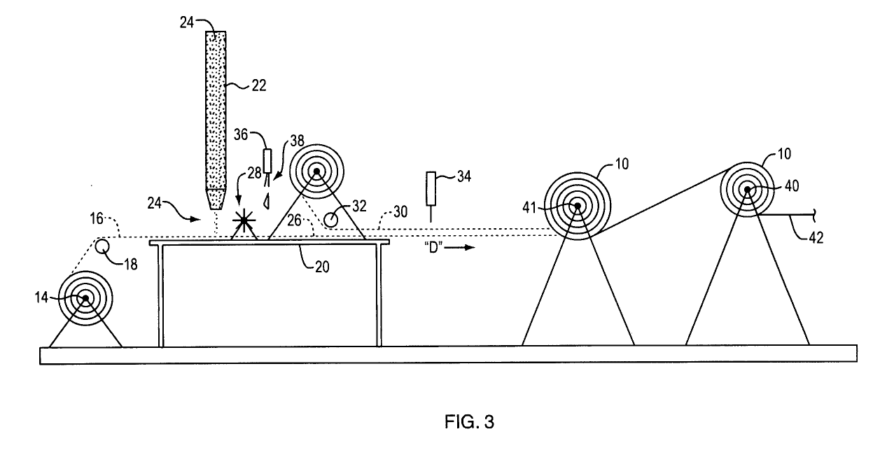

FIG. 4 is a side elevational view of a production line for the distribution of an additive on the blanket undergoing assembly;

FIG. 5 is a perspective view of a completed assembled product constructed according to the principles of the present invention; and

FIG. 6 is a sectional view of the constructed blanket taken along the lines 6-6 in FIG. 5, arranged on a support surface.

### BRIEF SUMMARY OF THE INVENTION

The present invention relates to surface control products and methods for improving the performance of rolled surface control products such as elongated multilayered fluid permeable blankets by the incorporation therein of natural and chemical additives utilized to absorb, stabilize or improve the condition of the surface on which that blanket or mat is placed, such as for example, a soil or a liquid surface, to prevent its erosion and hence stabilize it, or to absorb contaminants therefrom.

The production of such a fluid/liquid permeable surface stabilizing roll of mat begins with the drawing of a width of fabric from a source such as a roll comprised of a woven or extruded netting or the like to comprise a lower layer. The woven or extruded lower layer is drawn over a first roller and a subsequent work surface under which a reservoir of fiber is arranged. The fiber in this embodiment may consist of straw, coconut, wood fiber (excelsior), synthetic materials, or alternatively a mix of wood chips and/or that aforementioned matrix of straw and/or coconut or wood fibers. To ensure that that fibrous matrix is evenly distributed across the width of that lower layer of netting, a distributor comprising of a rotatable brush is disposed transversely across that movable web thereadjacent to evenly distribute any irregularities in that fibrous matrix. Alternatively that distributor may consist of gaseous jets programmed to blow excessive fiber from that traveling blanket.

As that movable web and fibrous matrix travels downstream, the upper layer of material is rolled on and pressed against the lower layer thereof by a subsequent variable pressure roller traveling multilayer blanket moves downstream to a stitching station where one or more sewing heads apply a continuous stitching thread transversely and longitudinally long in the traveling web of fibrous material sandwiched between the upper and lower layer of the netting. In a further embodiment, the upper layer may be disregarded and the fiber matrix applied only to the lower or bottom web. The movable web of fibrous material runs through a chemical application and distributor arrangement, where granular or powder particles are dropped onto the moving web in therebeneath. The elongated blankets may be stretch wrapped about a subsequent roller to ensure its tightness and alignment and packaged by a containment wrap.

A further embodiment of the present invention comprises the production of a surface stabilizing roll. That mat begins with the drawing of a width of fabric from a source such as a roll comprised of a woven or extruded netting or the like to comprise a lower layer. The woven or extruded lower layer is drawn over a first roller and a subsequent work surface under which a reservoir of fiber is arranged. The fiber in this embodiment may consist of straw, coconut, wood fiber (excelsior), synthetic material or a blend thereof. To ensure that the fiberous matrix is evenly distributed across the width of that lower layer of netting, a distributor comprising of a rotatable brush is disposed transversely across that movable web thereadjacent to evenly distribute any irregularities in that fibrous matrix. Alternatively that distributor may consist of gaseous jets programmed to blow excessive fiber from that traveling blanket. Subsequent to the evening out of the fibrous matrix by the distributor, an application of soil stabilizing or vegetation enhancing material is dripped or sprayed onto the fibrous matrix prior to its being covered by the top or upper layer of woven web material or prior to the application of stitching.

As that movable web and fibrous matrix travels downstream, the upper layer of material is rolled onto and pressed against the lower layer thereof by a subsequent variable pressure roller. The traveling multilayer blanket moves downstream to a stitching station where one or more sewing heads apply a continuous stitching thread transversely and longitudinally along the traveling web of fibrous material sandwiched between the upper and lower layer of the netting. Alternatively, the upper layer of netting may be omitted and the fiber matrix attached directly to the bottom or lower web. The elongated blankets may be stretch wrapped about a subsequent roller to ensure its tightness and alignment and packaged by a containment wrap.

A yet further monument of the present invention comprises the production of a surface stabilizing roll of mat or blanket begins with the drawing of a width of fabric from a source such as a roll comprised of a single or multiple array of woven netting or the like to comprise a lower layer of the elongated blanket. The woven lower layer is drawn over a first roller and a subsequent work surface under which a reservoir of fiber is arranged. The fiber in this embodiment may consist of straw, coconut, wood fiber (excelsior), synthetic material or a blend thereof. To ensure that that fibrous matrix is evenly distributed across the width of that lower layer of netting, a distributor comprising of a rotatable brush may be disposed transversely across that movable web thereadjacent to evenly distribute any irregularities in that fibrous matrix. Alternatively that distributor may consist of gaseous jets programmed to blow excessive fiber from that traveling blanket. Subsequent to the leveling out of the fibrous matrix by the distributor, an application of soil stabilizing or vegetation enhancing material (i.e. fertilizer and or water absorbent chemicals) is dropped/blown upon or shaken from an appropriate material distributor onto the fibrous matrix traveling therebelow, prior to its being covered by the (optional) top or upper layer of woven web material.

As that movable web and fibrous matrix travels downstream, the upper layer of material is rolled onto and pressed against the lower layer thereof by a subsequent variable pressure roller traveling multilayer blanket moves downstream to a stitching station where one of more sewing heads apply one or more continuous stitching thread patterns transversely and longitudinally along the traveling web of fibrous material deposited onto or optionally sandwiched between the upper and lower netting layers. The elongated blanket is subsequently stretched and wrapped about a subsequent roller to ensure its tightness and alignment and packaged within a containment wrap.

A yet still further monument of the present invention comprises the production of a surface stabilizing roll of mat or blanket which begins with the drawing of a width of fabric from a source such as a roll comprised of a single or multiple array of woven netting or the like to comprise a lower layer of the elongated blanket. The woven lower layer is drawn over a first roller and a subsequent work surface under which a reservoir of fiber is arranged. The fiber in this embodiment may consist of straw, coconut, wood fiber (excelsior) or a blend thereof. To ensure that the fibrous matrix is evenly distributed across the width of that lower layer of netting, a distributor comprising of a rotatable brush may be disposed transversely across that movable web thereadjacent to evenly distribute any irregularities in that fibrous matrix. Alternatively that distributor may consist of gaseous jets programmed to blow excessive fiber from that traveling blanket. Subsequent to the leveling out of the fibrous matrix by the distributor, an application of soil stabilizing material or vegetation enhancing material may be dropped/blown upon or shaken from an appropriate material distributor onto the fibrous matrix traveling therebelow, at any location between the stitching of the layers together but subsequent to its being covered by the top or upper layer of woven web material so as to insure full depth of the fiber matrix and the proper distribution of such chemical agents therewithin.

As that movable web and fibrous matrix travels downstream, the upper layer of material is rolled onto and pressed against the lower layer thereof by a subsequent variable pressure roller. The traveling multilayer blanket moves downstream to a stitching station where one of more sewing heads apply one or more continuous stitching thread patterns transversely and longitudinally along the traveling web of fibrous material sandwiched between the upper and lower netting layers. The elongated blanket is subsequently stretched and wrapped about a subsequent roller to ensure its tightness and alignment and packaged within a containment wrap.

The elongated multilayered, chemically enhanced or otherwise treated mat or web or blanket of rolled control product has a dispersal of chemical agents therein which have been deposited either by spraying, dropping, painting, dipped in liquid or a powder or granular form so as to add such chemical agents to flocculate, stabilize and or bind the soil particles together or bind those particles of soil or surface material to or within the control blanket. Further, additional chemical agents may be added/applied to support or enhance the establishment of vegetation (fertilizers) or as seeds/seedlings to initiate new growth or pest control agents (insecticides) to kill and/or minimize bugs, insects, small rodents and vegetation destroyers or the like. Such chemical agents may be a time release material which is designed to permeate the control blanket and slowly leach from or escape into the surface on which the blanket is deposited. Such chemical agents such as for example latex, coconut oil, neem oil may be applied to the blankets, to extend the performance time and/or to aid in the development of the integrity of the multilayered assembly and in the case of soil, to help control of the erosion of thereof. The latex or other additives may be dissolvable or permanent and may leach into the soil when that elongated blanket or mat is utilized for erosion control. Water or other liquids or fluids may be absorbed from or through the lower surface on which the blanket or mat is placed to activate those chemical agents within that blanket or mat. Those chemical agents may include tackifiers, flocculants, polyacrylamides or other soil stabilizers and or amendments or combinations thereof. The permeable nature of the blanket or mat permits the travel of those chemical agents from the mat into the surface of any soil therebeneath or permits the absorption of fluids into that mat for further activation of those time releasable chemical agents therein, or for absorption of hazardous material there within.

The present invention thus comprises a production system for the manufacture of erosion control blankets for soil stability and turf management, comprising one or more of the following steps including: drawing an elongated bottom netting across a support table; depositing a fibrous matrix of material onto the moving bottom netting; applying a roll of top netting upon the fibrous matrix; bindingly sandwiching the top and bottom netting layers together to secure the matrix therebetween; and applying a soil stabilizing treatment to the erosion control blanket prior to or during a wrapping of the blanket. The soil treatment is preferably selected from the group comprising: a tackifier, a flocculant, a polyacrylamide, or the like. The soil treatment is applied by a gravity feed arrangement, or by a pressurized spray arrangement, or by a biased painting arrangement. The top layer of netting material is fluid permeable. The bottom layer of netting material is fluid permeable.

The invention also comprises a multi-layered surface control blanket for soil stability and turf management, comprising a sandwiching of: a fluid permeable lower layer of flexible material; a fluid permeable upper layer of flexible material; at least one intermediate layer of fibrous material treated with a displaceable chemical agent, wherein the chemical agent comprises one or more soil treatment agents selected from the group comprising: a tackifier, a flocculant, a polyacrylamide, a fertilizer, an insecticide and a visible marker or indicia of date/content/application or the like. At least a portion of the chemical agent arranged within the intermediate layer of fibrous material is preferably a time release chemical agent. The chemical agent is driven into the intermediate or fibrous layer during a sandwiching manufacturing step before the (optional) upper layer of flexible material is applied to the intermediate and the lower layer of flexible material.

The invention also comprises a multi-layered surface control blanket for soil stability and turf management, comprising a sandwiching of: a fluid permeable lower layer of flexible material; at least one intermediate layer of fibrous material treated secured to the lower layer of flexible material; a displaceable chemical agent, wherein the chemical agent comprises a soil treatment agent selected from the group consists of a tackifier, a flocculant, a growth control agent, a pest control agent, a scent masking or enhancing agent, and a polyacrylamide; wherein at least one of the chemical agents within the blanket is evaporative into the air; and/or wherein at least one of the chemical agents within the blanket is a time release agent for the slow displacement of that chemical agent from the blanket and into the soil therebeneath, and/or wherein at least one of the chemical agents within the blanket is a time release agent or odor changing content, for the slow displacement of that odor modifying or changing chemical agent from the blanket (such as a perfume) and into the air above the blanket, and wherein the blanket is utilizable for placement on a body of liquid such as fuel, water or hazardous waste material to detoxify, de-scent, stabilize, constrain, absorb or otherwise control such matter.

### DETAILED DESCRIPTION OF THE PREFERRED EMBODIMENTS

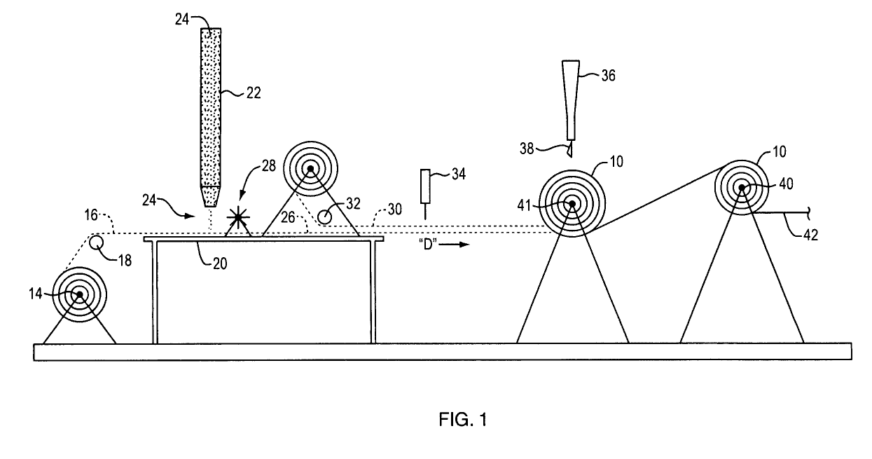

Referring now to the drawings in detail, and particularly to FIG. 1, there is shown the present invention which comprises a surface control product 10 and methods for improving the performance of rolled surface control products such as elongated multilayered fluid permeable blankets by the incorporation therein of natural and chemical additives utilized to absorb, stabilize, leach from, or improve the condition of the surface on which that blanket or mat is placed, such as for example, a soil or a liquid surface, to prevent its erosion and hence stabilize it, or to absorb contaminants therefrom, or to add protection in the form of insecticides/biocides, or in a further preferred embodiment, making the treated area more socially acceptable by scent or odor enhancers/camouflaging agents or pest repellant agents in the blanket or mat to disperse therefrom, either directly into the soil, or wet or dry surface beneath the mat or blanket or also into the wind/air above the mat or blanket.

The production of such a fluid/liquid permeable surface stabilizing roll or mat product 10 such as shown in FIG. 1 begins with the drawing of a width of web fabric from a source such as a roll 14 comprised of a woven netting or the like to comprise a lower layer 16. The woven lower layer 16 is drawn over a first roller 18 and onto a subsequent work surface 20 under which a fiber containing reservoir 22 is arranged. The fiber 24 in this embodiment may consist of straw, coconut, wood fibers (excelsior) or a blend thereof. To ensure that that fibrous matrix mid-layer 26 is evenly distributed across the width of that lower netting layer 16, a distributor 28 comprising of a rotatable brush is disposed transversely across that movable web (lower layer 16 and mid-layer fibrous matrix 26) thereadjacent to evenly distribute any irregularities in that fibrous matrix 26. Alternatively that distributor 28 may consist of gaseous jets programmed to blow excessive fiber from that traveling web or blanket 10.

In one preferred embodiment, as that movable lower layer 16 and fibrous matrix 26 travel downstream, an upper layer of woven material 30 is rolled thereon and pressed against the matrix 26 and lower layer 16 thereof by a subsequent variable pressure roller 32 as the traveling multilayer blanket 10 moves downstream, as indicated by arrow “D” to a stitching station where one of more sewing heads 34 apply a continuous stitching thread transversely across and longitudinally along the traveling web of fibrous material 26 sandwiched between the upper and lower layer 30 and 16 of the netting blanket 10. The movable web of sandwiched fibrous material 26 runs through a chemical application and distributor arrangement 36, where granular or powder particles 38 are dropped onto the moving web or blanket 10 therebeneath, under roller 41. The elongated blankets 10 are subsequently stretch wrapped from roller 41 about a subsequent roller 40 to ensure its tightness and alignment and then packaged in a chemically impermeable containment wrap 42.

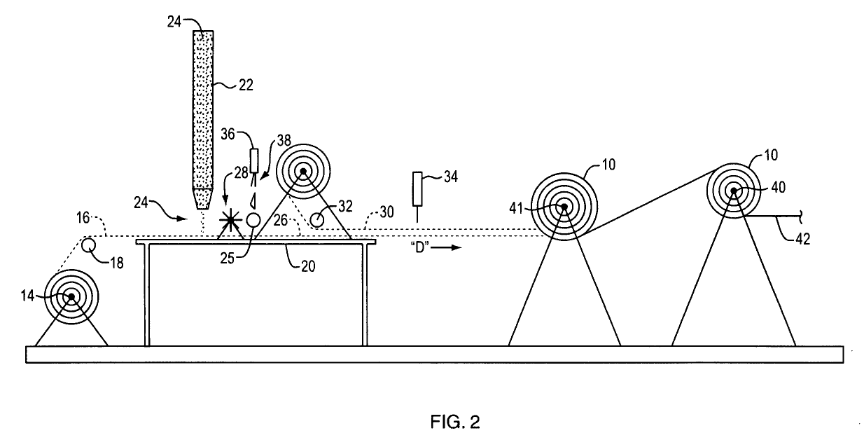

A further monument of the present invention comprises the production of a surface stabilizing role wherein that mat 10 begins with the drawing of a width of fabric from a source such as a roll 14 comprised of a woven or extruded netting or the like to comprise a lower layer 16. The woven lower layer 16 is preferably drawn over a first roller 18 and onto a subsequent work surface 20 under which a fiber containing reservoir 22 is arranged. The fiber 24 in this embodiment may consist of straw, coconut, wood fibers (i.e., excelsior) or a blend of the aforementioned mix. To ensure that that fibrous matrix mid-layer 26 is evenly distributed across the width of that lower netting layer 16, a distributor 28 comprising of a rotatable brush is preferably disposed transversely across that movable web (lower layer 16 and mid-layer matrix 26) thereadjacent to evenly distribute any irregularities in that fibrous matrix 26. Alternatively that distributor 28 may consist of gaseous jets programmed to blow excessive fiber matrix 26 from that traveling web or blanket 10. Subsequent to the evening out of the fibrous matrix 26 by the distributor 28, an application of soil stabilizing material 38 is dripped or sprayed onto the fibrous matrix 24 prior to its being covered by the top or upper layer of woven or extruded web 30 material, as represented in FIG. 2.

As that movable web and fibrous matrix travels downstream, the upper layer of woven permeable material 30 is rolled onto and pressed against the lower layer 16 thereof by a subsequent variable pressure roller 32 as the traveling multilayer blanket 10 moves downstream to a stitching station where one or more sewing heads 34 apply a continuous stitching thread transversely and longitudinally therealong in/on the traveling web of fibrous material 24 sandwiched between the upper and lower layer of the netting 30 and 16, as shown in FIG. 2. The elongated blanket or web product 10 is the stretch wrapped about a subsequent roller 40 from support roller 41, to ensure its tightness and alignment and packaged by a containment wrap 42.

A yet further monument of the present invention comprises the production of a surface stabilizing roll of mat or blanket product 10 begins with the drawing of a width of fabric from a source such as a roll comprised of a single or multiple array of woven netting or the like to comprise a lower layer 16 of the elongated web or blanket 10. The permeable woven or extruded lower layer 16 is preferably drawn over a first roller 18 and a subsequent work surface 20 under which a reservoir of fiber is arranged. The fiber 24 in this embodiment may consist of a mix of straw and/or coconut, and/or wood fibers (excelsior) or the like, or a blend thereof. To ensure that that fibrous matrix 24 is evenly distributed across the width of that lower layer of netting 16, a distributor 28, preferably comprising a rotatable brush, may be disposed transversely across that movable web (lower layer 16 and mid-layer fibrous matrix 26) thereadjacent to evenly distribute any irregularities in that fibrous matrix 26. Alternatively that distributor 28 may consist of gaseous jets programmed to blow excessive fiber 24 from that traveling blanket. Subsequent to the leveling out of the fibrous matrix by the distributor 28, an application of soil treating, stabilizing or enhancing material or chemical agent 38 is dropped/blown upon or shaken from an appropriate material distributor 36 onto the fibrous matrix 26 traveling therebelow, prior to its optionally being covered by the top or upper layer 30 of woven or extruded web material.

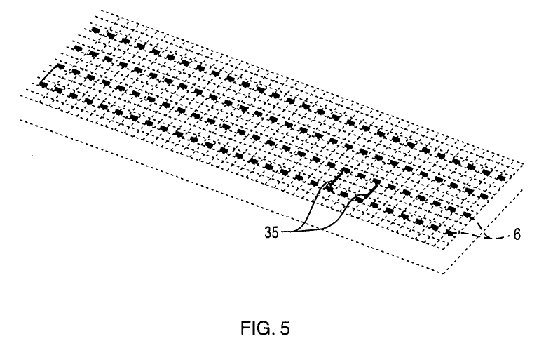

As that movable web and fibrous matrix travels downstream, the upper layer 30 of preferably fluid permeable material is rolled onto and pressed against the lower layer 16 thereof by a subsequent variable pressure roller 32 whence the traveling multilayer blanket 10 moves downstream to a stitching station where one of more sewing heads 34 supported from an overhead support, apply one or more continuous stitching thread patterns 35, as may be seen in FIG. 5, either or both transversely and longitudinally along the traveling web of fibrous material 24 sandwiched between the upper and lower netting layers 30 and 16. The elongated web or blanket product 10 is subsequently stretched about a roller 41 and then wrapped about a subsequent roller 40 to ensure its tightness and alignment and packaged within a containment wrap 42.

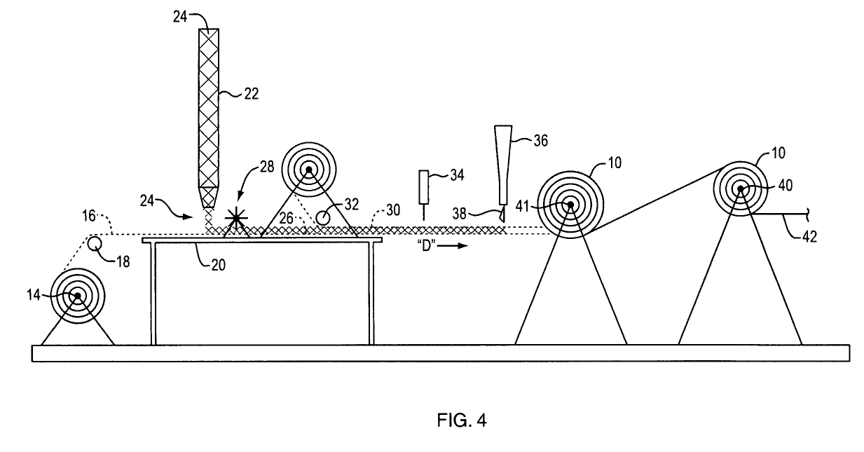

A yet still further monument of the present invention is shown in FIG. 4, which comprises the production of a surface stabilizing roll of mat or blanket 10 which begins with the drawing of a width of fabric from a source such as a roll 14 comprised of a single or multiple array of woven netting or the like to comprise a lower layer 16 of the elongated blanket product 10. The preferably woven lower layer 16 is drawn over a first roller 18 and a subsequent work surface 20. A fiber reservoir 22 containing a fibrous matrix is arranged over the work surface, as represented in FIG. 4. The fiber 24 in this embodiment may consist of straw, coconut, or alternatively a mix of wood fibers (excelsior) or the like, or a blend of these or other absorbent or hydrophilic or hydrophobic material. To ensure that the fibrous matrix mid-layer 26 is evenly distributed across the width of that lower netting layer 16, a distributor 28, comprising for example, a rotatable brush, may be disposed transversely across that movable web thereunder, to evenly distribute any irregularities in that mid-layer fibrous matrix 26. Alternatively that distributor 28 may consist of gaseous jets programmed to blow excessive fiber 24 from that traveling combination of fiber 24 and the lower supportive layer of fabric 16. Subsequent to the leveling out of the mid-layer of fibrous matrix 26 by the distributor 28, a saturation application of soil stabilizing material or chemical agent is dropped/blown upon or shaken from an appropriate overhead material distributor onto the fibrous matrix 26 traveling therebelow, at any location before during or subsequent to the stitching of the layers 16 and 30 about the mid-layer 26 together, so as to insure full penetration and distribution of such chemical agents 38 therewithin.

As that movable lower layer 16 and fibrous matrix product 26 travels downstream, the upper layer of material 30 is rolled onto and pressed against the lower layer 16 thereof by a subsequent variable pressure roller 32 against the traveling multilayer blanket 10 as it moves downstream to a stitching station where one of more sewing heads 34 apply one or more continuous stitching thread patterns transversely and longitudinally along the traveling web of fibrous material 26 sandwiched between the upper and lower netting layers 30 and 16. The elongated blanket product 10 is subsequently drawn about an intermediate roller 41 and stretched and wrapped about a subsequent roller 40 to ensure its tightness and alignment and safe enclosure packaging within a containment wrap 42, as shown in FIG. 4.

The elongated multilayered, chemically treated mat or web or blanket of rolled control product 10 has a dispersal of chemical agents 38 throughout its thickness and multiple layers, which chemical agent(s) 38 have been deposited either by spraying, dropping, painting, through dipped in a liquid bath, powder or granular form, as aforementioned, so as to add such chemical agents to flocculate, stabilize and or bind the soil particles together, or bind those particles of soil or surface material to or within the control blanket, or to enhance or retard the vegitative growth beneath/within or over that blanket, such agents also including fertilizers, weed growth retardants, pesticides, plant or insect biocides, odor enhancers or neutralizers or scent enhancers such as perfumes or flavored scents to make such treated area more desirable to humans or less desirable to bugs, certain wildlife or the like. Such chemical agents 38 may preferably be or include a “time release” material which is designed to permeate the control blanket and at least partially escape by leaching, melting or dissolving into the surface beneath the mat 10, or evaporating onto the air or wind above the mat or blanket. Such chemical agents 38, such as for example, the latex, coconut oil or neem oil, a perfume or odor enhancer or mask and may be applied to the blanket product 10, to extend the performance time and/or to aid in the development of the integrity of the multilayered product assembly 10 and in the case of soil, to help control of the erosion of thereof, once the blanket product 10 has been lain thereover. The latex agent or the other chemical agents 38 recited hereinabove, may be dissolvable or be permanently entrained within the mat or blanket in uniform or area selective distribution therein. Those agents may in one embodiment, leach into and dissolve in the soil or lower surface 50 when that elongated blanket or mat is utilized for erosion control, or surface treatment for soil retention, enhancement, vegetation growth or hinderance. Water or other liquids or fluids 52 may be absorbed into the matrix 26 from the lower surface 50 on which the blanket or mat is placed to activate those chemical agents within that blanket or mat 10.

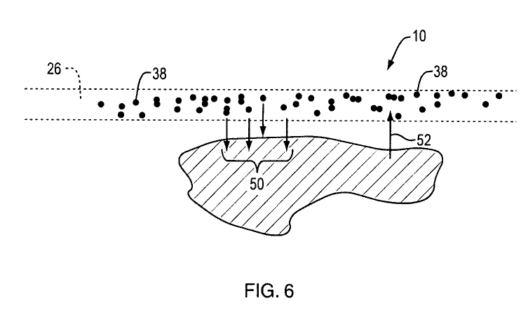

Those chemical agents 38 may include tackifiers (as for example guar gum, starch, plantego, potato starch), and also flocculants, polyacrylamides or other soil stabilizers and or amendments or fertilizers or poisons to control certain weed, insects, pests or combinations thereof. The permeable nature of the blanket or mat product 10 thus permits the movement of those chemical agents 38 from the mat 10 into the surface 50 therebeneath or permits the absorption of fluids 52 into that mat for further activation of those alternatively preferable “time releasable” chemical agents 38 therein, or for absorption of what could be “hazardous” material 52, for example, oil, gasoline or the like, there within, as represented in FIG. 6.

1. A production system for the manufacture of erosion control blankets for soil stability and turf management, comprising:
drawing an elongated bottom netting across a support table;
depositing a fibrous matrix of material onto the moving bottom netting;
applying a roll of top netting upon the fibrous matrix;
bindingly sandwiching the top and bottom netting layers together to secure the matrix therebetween; and
applying a soil stabilizing, vegetation enhancement/retardant, soil longevity/integrity enhancement treatment agent to the erosion control blanket prior to or during a wrapping of the control blanket.

2. The production system as recited in claim 1, wherein the soil treatment agent is selected from the group consisting of: a tackifier, a flocculant, a polyacrylamide, fertilizer or soil longevity stabilizer.

3. The production system as recited in claim 2, wherein the treatment agent consists of a latex agent, coconut oil, neem oil, an odor mask, a pesticide, a biocide and an odor modifier.

4. The production system as recited in claim 2, wherein the soil treatment is applied by a gravity feed arrangement.

5. The production system as recited in claim 2 wherein the soil treatment is applied by a pressurized spray arrangement.

6. The production system as recited in claim 2 wherein the soil treatment is applied by a biased painting arrangement.

7. The production system as recited in claim 1, wherein the top layer of netting material is fluid permeable.

8. The production system as recited in claim 1, wherein the bottom layer of netting material is fluid permeable.

9. The production system as recited in claim 2 wherein the soil treatment comprises an agent which is time releasable.

10. A multi-layered surface control blanket for soil stability and turf management, comprising a sandwiching of:
a fluid permeable lower layer of flexible material;
a fluid permeable upper layer of flexible material;
at least one intermediate layer of fibrous material treated with a displaceable chemical agent, wherein the chemical agent comprises a soil treatment agent selected from the group comprising: a tackifier, a flocculant, a growth control agent, a pest control agent, a scent masking or enhancing agent, and a polyacrylamide.

11. The surface control blanket as recited in claim 10, wherein at least a portion of the chemical agent arranged within the intermediate layer of fibrous material is a time release chemical agent.

12. The surface control blanket as recited in claim 10, wherein the chemical agent is driven into the intermediate layer during a sandwiching manufacturing step before the upper layer of flexible material is applied to the intermediate and the lower layer of flexible material.

13. A multi-layered surface control blanket for soil stability and turf management, comprising a sandwiching of
a fluid permeable lower layer of flexible material;
at least one intermediate layer of fibrous material treated secured to the lower layer of flexible material;
a displaceable chemical agent, wherein the chemical agent comprises a soil treatment agent selected from the group consists of: a tackifier, a flocculant, a growth control agent, a pest control agent, a scent masking or enhancing agent, and a polyacrylamide.

14. The multi-layered surface control blanket as recited in claim 13, wherein at least one of the chemical agents within the blanket is evaporative into the air.

15. The multi-layered surface control blanket as recited in claim 13, wherein at least one of the chemical agents within the blanket is a time release agent for the slow displacement of that chemical agent from the blanket and into the soil therebeneath.

16. The multi-layered surface control blanket as recited in claim 13, wherein at least one of the chemical agents within the blanket is a time release agent or odor changing content, for the slow displacement of that odor changing chemical agent from the blanket and into the air above the blanket.
